(19) United States
(12) Patent Application Publication
(10) Pub. No.: US 2004/0024152 A1
(43) Pub. Date: Feb. 5, 2004

(54) Gas hydrate formation inhibitor and method for inhibiting gas hydrate formation with the same

(76) Inventors: Masayuki Toyama, Kanagawa (JP); Masaaki Seya, Kanagawa (JP)

Correspondence Address: FITCH EVEN TABIN AND FLANNERY, 120 SOUTH LA SALLE STREET, SUITE 1600, CHICAGO, IL, 60603-3406, US

(21) Appl. No.: 10/343,122

(22) PCT Filed: Jul. 26, 2001
(86) PCT No.: PCT/JP01/06458

(30) Foreign Application Priority Data
Jul. 28, 2000 (JP) 2000-228430
May 10, 2001 (JP) 2001-139989

(51) Int. Cl. C08F 4/28

(52) U.S. Cl. 526/227; 526/303.1

(57) ABSTRACT

A gas hydrate formation inhibitor consisting of an amphiphilic polymer (such as N-isopropylmethacrylamide (co)polymer) which bears nonionic groups (such as hydroxyl groups) at the polymerization-initiation and -termination ends and has a weight-average molecular weight of 500 to 10,000; and a method for inhibiting gas hydrate formation by adding the gas hydrate formation inhibitor to a system wherein a gas hydrate is to be formed. According to this invention, the formation of gas hydrates can be inhibited, and gas hydrates can be stabilized from the viewpoints of theories of chemical equilibrium and rate process.

### TECHNICAL FIELD

The present invention relates to gas hydrate (methane hydrate, etc.) formation and dissociation-controlling agents and to a gas hydrate formation and dissociation-controlling method.

### BACKGROUND ART

It is known that keeping aqueous media which contain dissolved gas molecules including carbon dioxide gas or hydrocarbons such as methane and ethane at a specific temperature and pressure produces “gas hydrates”, defined as icy crystals wherein the dissolved gas molecules are surrounded by water molecules. Gas hydrates formed during mining and shipping of crude oil and natural gas often constitute a cause pipeline clogging, creating a major obstacle to safe and continuous operation.

Gas hydrates are also known to be naturally present under high-pressure, low-temperature conditions. For example, studies have confirmed the existence of huge reserves of methane gas hydrates (hereinafter referred to as “methane hydrates”) in vast zones under permafrost in cold regions such as Siberia or Alaska, or a few hundred meters or more below the sea floor. In recent years, methane hydrates have become the focus of attention as an energy source with low emissions of carbon dioxide and nitrogen or sulfur oxides, which are a source of environmental pollution, and a safe method for retrieving natural methane hydrates in a stable state has therefore been desired.

LNG (Liquid Natural Gas) methods are usually employed for transport and storage of fuel gas and especially methane gas, but because of the high construction and building costs for LNG bases and LNG transport tankers, projects on large gas fields with substantial reserves are generally planned on the assumption of extended reimbursement periods. LNG is therefore not suitable for small-scale gas fields and can even be an impediment to development of small-scale gas fields. The use of gas hydrates for transport and storage of natural gas is considered to be more cost effective than LNG in the case of small-scale gas fields, and the cost can be further reduced by stabilizing the storage of gas hydrates under milder conditions by using additives and the like.

Thus, it is desirable to inhibit or delay formation of gas hydrates during pipeline transport of water-containing drilled gas such as methane, while it is also desirable to accelerate and stabilize formation of extracted gas hydrates during their shipping and storage and to accelerate dissociation and/or inhibit formation of gas hydrates during extraction of the gas hydrates from the sea floor or the ground. In order to stabilize or delay dissociation of gases such as methane when their gas hydrates are utilized as storage means, gas hydrate formation and dissociation controlling agents must satisfactorily exhibit the following apparently contradictory aspects of performance.

(1) They must inhibit formation of gas hydrates (equilibrium formation inhibition) or delay their formation rate (kinetic formation inhibition, or formation delay).

(2) They must accelerate formation of gas hydrates (equilibrium stabilization, or kinetic formation acceleration) or delay the dissociation rate of formed gas hydrates (kinetic stabilization, or dissociation delay).

International Patent Publication WO98/53007 describes various additives and stabilizers for formed gas hydrates which function to inhibit formation and growth of gas hydrates and/or aggregation of unstable nucleus structures at the initial stage of gas hydrate formation, and this publication teaches that a polymer composed primarily of an N-alkyl (meth)acrylamide-based monomer and an N,N-dialkyl (meth)acrylamide-based monomer, having a weight-average molecular weight in the range of 400-7000 and a cloud point of 50° C. or higher with a distilled water concentration of 1 wt %, is effective for controlling formation of gas hydrates. Specifically, such polymers include acryloylpyrrolidine homopolymers, acryloylpiperidine homopolymers and isopropylacrylamide/2-acrylamido-2-methylpropanesulfonate copolymers. However, as polymers in the specified molecular weight range are essentially oligomers, the properties of the ends of the polymers are not controlled, despite the fact that they are known to have a major effect on the properties of the polymer molecule as a whole.

International Patent Publication WO97/07320 teaches that amphipathic polymers with a certain structure exhibit a high effect as hydrate inhibitors (hydrate formation inhibitors). However, this publication nowhere mentions the properties of the polymer end groups or the method of producing the polymers.

International Patent Publication WO96/41786 describes a process using N-isopropylmethacrylamide and N-methyl-N-vinylacetamide with the non-ionic initiator azobisisobutyronitrile, using an amphipathic polymer copolymerized in benzene as the gas hydrate inhibitor. However, as the amphipathic polymer used has a high weight-average molecular weight, almost no effect is produced by both of its non-ionic ends.

As examples of additives with gas hydrate formation-accelerating effects, particularly using methane gas, there may be mentioned the aliphatic amines, alcoholic cyclic compounds and tetrahydrofurans described in Japanese Unexamined Patent Publication No. 4-316795, Japanese Unexamined Patent Publication No. 6-17089, Japanese Unexamined Patent Publication No. 6-25021 and Japanese Unexamined Patent Publication No. 9-49600. Such additives, however, are all low molecular weight compounds and, therefore, when dissociating hydrates to obtain gas, it is difficult to completely separate the additives due to reasons of vapor pressure. In addition, the hydrate stabilizing effect is unsatisfactory.

Japanese Unexamined Patent Publication No. 10-216505 describes an additive for hydrate formation using a surfactant containing a silicone resin, but this publication relates to a method for facilitating contact between gas molecules and water by lowering the water surface tension in a hydrate-forming system using a silicone resin-containing surfactant, and it provides no effect of accelerating formation of, or stabilizing, the gas hydrate structure.

Also, an example of Japanese Unexamined Patent Publication No. 10-338715 mentions polyacryloylpyrrolidine with a molecular weight of 5,000, produced using the non-ionic 2,2′-azobis(cyclohexane-1-carbonitrile) (V-40, product of Wako Pure Chemical Industries) as a polymerization initiator. A gas hydrate inhibitor is also mentioned in this publication as an example of use of the polymer. However, this example merely describes production of the polymer, while the performance of the resulting polymer as a gas hydrate inhibitor is not confirmed. In addition, numerous ionic and non-ionic polymerization initiators are cited for use as prior art, of which the V-40 used in the example is merely one, and therefore the use of ionic polymerization initiators is allowed. Consequently, Japanese Unexamined Patent Publication No. 10-338715 cannot be considered to disclose a gas hydrate formation and dissociation-controlling agent comprising an amphipathic polymer, wherein the polymerization initiation and polymerization termination ends of the polymer are non-ionic and the weight-average molecular weight is in the range of 500-10,000.

### DISCLOSURE OF THE INVENTION

It is an object of the present invention to provide gas hydrate formation and dissociation-controlling agents and a gas hydrate formation and dissociation-controlling method exhibiting both the function of inhibiting formation of gas hydrates and the function of equilibrium and kinetic stabilization of gas hydrates.

The present inventors achieved the invention upon finding that amphipathic polymers having a specified weight-average molecular weight and specific properties for the polymerization ends of the polymer exhibit very excellent performance as gas hydrate formation and dissociation-controlling agents.

The invention therefore provides gas hydrate formation and dissociation-controlling agents which are amphipathic polymers having non-ionic polymerization initiation and polymerization termination ends of the polymers, and having weight-average molecular weights in the range of 500-10,000. Such amphipathic polymers are preferably obtained by (co)polymerization of amphipathic monomers.

The invention further provides a gas hydrate formation and dissociation-controlling method which comprises adding any of the aforementioned gas hydrate formation and dissociation-controlling agents to a gas hydrate-forming system.

### BRIEF DESCRIPTION OF THE DRAWINGS

FIG. 1 is a schematic block diagram of an apparatus for evaluation of gas hydrate formation and dissociation-controlling performance.

### BEST MODE FOR CARRYING OUT THE INVENTION

An amphipathic polymer used for the invention has non-ionic polymerization initiation and polymerization termination ends and has a weight-average molecular weight in the range of 500-10,000. Here, “amphipathic polymer” is a general term for any polymer having a hydrophobic group and a hydrophilic group, and it may be obtained by, for example, homopolymerization of an amphipathic monomer, copolymerization of an amphipathic monomer and a hydrophilic or hydrophobic monomer which is copolymerizable therewith, or copolymerization of a hydrophilic monomer and hydrophobic monomer. The method for producing the amphipathic polymer is preferably a method of (co)polymerizing an amphipathic monomer, that is, a method of obtaining a homopolymer by homopolymerization of an amphipathic monomer or a method of obtaining a copolymer of a copolymerizable hydrophilic or hydrophobic monomer with an amphipathic monomer. In the case of a copolymer, the proportion of the amphipathic monomer component in the polymer is preferably 10-99 mole percent, and more preferably 50-90 mole percent.

For the purpose of the invention, an amphipathic monomer is one having both a hydrophilic group and a hydrophobic group, and also having a polymerizable group. For example, it is “a monomer soluble in water and soluble in solvents that are not miscible with water (commonly referred to as non-aqueous solvents)”, which is also polymerizable. For the invention, however, monomers which are not definitely amphipathic alone but are amphipathic as polymers will also be referred to as “amphipathic monomers” for convenience.

As examples of amphipathic monomers there may be mentioned N-ethyl (meth)acrylamide, N-cyclopropyl (meth)acrylamide, N-isopropyl (meth)acrylamide, N-n-propyl (meth)acrylamide, N-methyl-N-ethyl (meth)acrylamide, N,N-diethyl (meth)acrylamide, N-methyl-N-isopropyl (meth)acrylamide, N-methyl-N-n-propyl (meth)acrylamide, N-(meth)acryloylpyrrolidine, N-(meth)acryloylpiperidine, N-2-ethoxyethyl (meth)acrylamide, N-3-methoxypropyl (meth)acrylamide, N-3-ethoxypropyl (meth)acrylamide, N-3-isopropoxypropyl (meth)acrylamide, N-3-(2-methoxyethoxy)propyl (meth)acrylamide, N-3-(2-methoxyethoxy)propyl (meth)acrylamide, N-tetrahydrofurfuryl (meth)acrylamide, N-1-methyl-2-methoxyethyl (meth)acrylamide, N-1-methoxymethylpropyl (meth)acrylamide, N-(2,2-dimethoxyethyl)-N-(meth)acrylamide, N-(1,3-dioxolan-2-ylmethyl)-N-(meth)acrylamide, N-2-methoxyethyl-N-(meth)acrylamide, N-2-methoxyethyl-N-n-propyl (meth)acrylamide, N-2-methoxyethyl-N-isopropyl (meth)acrylamide, N,N-di(2-(ethoxyethyl) (meth)acrylamide, N-vinylpyrrolidone, N-vinylcaprolactam, N-isopropenylpyrrolidone, N-isopropenylcaprolactam and the like.

Among these, N-ethyl (meth)acrylamide, N-cyclopropyl (meth)acrylamide, N-isopropyl (meth)acrylamide, N-n-propyl (meth)acrylamide, N-methyl-N-ethyl (meth)acrylamide, N,N-diethyl (meth)acrylamide, N-methyl-N-isopropyl (meth)acrylamide, N-methyl-N-n-propyl (meth)acrylamide, N-(meth)acryloylpyrrolidine, N-(meth)acryloylpiperidine, N-vinylpyrrolidone, N-vinylcaprolactam are preferred, with N-isopropyl methacrylamide being particularly preferred.

The hydrophilic monomer has the properties of high interaction and high affinity with water, while also having a polymerizable group, and it will typically be a polymerizable water-soluble monomer.

As examples of hydrophilic monomers there may be mentioned N-(meth)acrylamide, N-methyl (meth)acrylamide, N,N-dimethyl (meth)acrylamide, N-(meth)acryloylmethyl homopiperazine, N-(meth)acryloylmethylpiperazine, N-2-hydroxyethyl-N-(meth)acrylamide, N-3-hydroxypropyl (meth)acrylamide, N-2-methoxyethyl (meth)acrylamide, N-3-morpholinopropyl (meth)acrylamide, N-(meth)acryloylmorpholine, N-2-methoxyethyl-N-methyl (meth)acrylamide, (meth)acrylic acid and its salts, 2-hydroxyethyl (meth)acrylate, ethyleneglycol (meth)acrylate, diethyleneglycol (meth)acrylate, polyethyleneglycol (meth)acrylate, propyleneglycol (meth)acrylate, butanediol (meth)acrylate, trimethylolpropane (meth)acrylate, dimethylaminoethyl (meth)acrylate, dimethylamidopropyl (meth)acrylamide, vinyl acetate, vinyl propionate, methyl vinyl ether, ethyl vinyl ether, 2-vinyl-2-oxazoline, 2-vinyl-4-methyl-2-oxazoline, 2-isopropyl-2-oxazoline, N-vinylacetamide, N-vinyl-N-methylacetamide, N-vinylformamide, N-vinyl-N-methylformamide, N-vinyl-N-n-propylpropionamide, N-vinyl-N-methylpropionamide, N-vinyl-N-i-propylpropionamide, N-vinylpropionamide, vinyl butyrate, N-allylamide, maleic acid, vinylimidazole, dimethylaminoethyl (meth)acrylate methylchloride, dimethylaminoethyl (meth)acrylate benzylchloride, 2-(meth)acrylamido-2-methylpropanesulfonic acid and its salts, (meth)acrylamide methanesulfonic acid and its salts, (meth)acrylamide ethanesulfonic acid and its salts, 2-(meth)acrylamido-n-butanesulfonic acid and its salts, glycosyloxyethyl acrylate, glycosyloxyethyl methacrylate, glycosyloxyethyl-α-ethyl acrylate, glycosyloxyethyl-β-methyl acrylate, glycosyloxyethyl-β,β-dimethyl acrylate, glycosyloxyethyl-β-ethyl acrylate, glycosyloxyethyl-β,β-diethyl acrylate, ethylene glycol, propylene glycol and the like.

Preferred among these monomers are N-(meth)acrylamide, N-methyl (meth)acrylamide, N,N-dimethyl (meth)acrylamide, N-(meth)acryloylmorpholine, N-2-methoxyethyl-N-methyl (meth)acrylamide, (meth)acrylic acid and its salts, 2-hydroxyethyl (meth)acrylate, ethyleneglycol (meth)acrylate, polyethyleneglycol (meth)acrylate, propyleneglycol (meth)acrylate, dimethylaminoethyl (meth)acrylate, vinyl acetate and 2-(meth)acrylamido-2-methylpropanesulfonic acid.

As examples of hydrophobic monomers there may be mentioned alkyl (meth)acrylate, alkyl (meth)acrylamide, heterocyclic (meth)acrylates, heterocyclic (meth)acrylamides, and vinylbenzenes optionally having lower alkyl groups or halogen atoms as substituents on the benzene rings. In particular, polymers partially consisting of monomer units derived from alkyl (meth)acrylate, alkyl (meth)acrylamide, heterocyclic (meth)acrylates or heterocyclic (meth)acrylamides are preferred as gas hydrate formation and dissociation-controlling agents from the standpoint of interaction with gas molecules in water by intermolecular forces.

There are no particular restrictions on the method for producing the amphipathic polymer, and for example, there may be mentioned methods such as aqueous solution polymerization, solution polymerization using organic solvents, bulk polymerization, precipitation polymerization, emulsion polymerization, reverse-phase emulsion polymerization, soap-free polymerization, suspension polymerization, reverse-phase suspension polymerization, and the like, using amphipathic monomers alone or amphipathic monomers with other monomers such as hydrophilic monomers as the starting materials. Among these polymerization methods, aqueous solution polymerization, solution polymerization using organic solvents, bulk polymerization, precipitation polymerization, emulsion polymerization and soap-free polymerization are particularly preferred.

For control of gas hydrate formation, it is important to control the interaction between the hydrophobic gas molecules and water molecules. It may be possible to more suitably control the interaction between gas molecules and water molecules by means of a random copolymer than a block copolymer of a hydrophilic polymer and amphipathic polymer. Consequently, a copolymer of a hydrophilic monomer and an amphipathic monomer is preferred from the standpoint of controlling the balance between hydrophilicity and hydrophobicity.

The solvent used for the polymerization may be appropriately selected depending on the polymerization method, and in most cases water, alcohols, acetic acid esters and ethers may be used. Since solvent-derived end groups are introduced into the polymer by chain transfer during polymerization, the solvent is preferably one which does not result in introduction of ionic end groups into the polymer. However, even when an ionic solvent is used for production and yields a polymer with ionic end groups, the terminal ionic groups can be rendered non-ionic for use as a gas hydrate formation and dissociation-controlling agent according to the invention.

The polymerization initiator serves as a polymerization initiating radical at the start of polymerization, and promotes polymerization by reaction with the monomer, so that a structure derived from the polymerization initiator is introduced at the polymerization initiation end of the polymer. A chain transfer agent-derived structure will also be included at the polymerization end when a chain transfer agent is used for polymerization.

A polymer used as a gas hydrate formation and dissociation-controlling agent according to the invention has no ionic groups at its ends, and it may therefore be produced by polymerization using non-ionic species for the polymerization initiator and chain transfer agent. This method is preferred for its low production cost and convenience. Such polymers may also be produced by using an ionic polymerization initiator for polymerization and then subsequently rendering the ends non-ionic.

As examples of non-ionic polymerization initiators there may be mentioned peroxides, organic peroxy acids, inorganic peroxy acids, non-salt water-soluble azobis compounds having no counter ions, non-water-soluble or poorly water-soluble azobis compounds, or redox systems comprising combinations of peroxides and reducing agents.

As examples of non-ionic polymerization initiators there may be mentioned nonionic ones such as 2,2′-azobis (4-methoxy-2,4-dimethylvaleronitrile), 2,2′-azobis (2,4-dimethylvaleronitrile), 2,2′-azobisisobutyronitrile, 2,2′-azobis(2-methylbutyronitrile), 1,1′-azobis(cyclohexane-1-carbonitrile), 2-phenylazo-4-methoxy-2,4-dimethylvaleronitrile, 2,2′-azobis[N-(2-carboxyethyl)-2-methylpropionamidine] dihydrate, 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis[2-methyl-N-(2-hydroxyethyl)propionamide], 2,2′-azobis(2-methylpropionamide) dihydrate, 2,2′-azobis(2,4,4-trimethylpentane), dimethyl-2,2′-azobis(2-methylpropionate), 2,2′-azobis[2-(hydroxymethyl)propionitrile], 4,4′-azobis(4-cyanovaleric acid), isobutyl peroxide, α,α′-bis(neodecanoylperoxy)diisopropylbenzene, cumyl peroxyneodecanoate, di-n-propyl peroxydicarbonate, diisopropyl peroxydicarbonate, 1,1,3,3-tetramethylbutyl peroxyneodecanoate, bis(4-t-butylcyclohexyl) peroxydicarbonate, 1-cyclohexyl-1-methylethyl peroxyneodecanoate, di-2-ethoxyethyl peroxydicarbonate, di(2-ethylhexylperoxy)dicarbonate, t-hexyl peroxyneodecanoate, dimethoxybutyl peroxydicarbonate, di(3-methyl-3-methoxybutylperoxy)dicarbonate, t-butyl peroxyneodecanoate, t-hexyl peroxypivalate, t-butyl peroxypivalate, 3,5,5-trimethylhexanoyl peroxide, octanoyl peroxide, lauroyl peroxide, stearoyl peroxide, 1,1,3,3-tetramethylbutylperoxy-2-ethyl hexanoate, succinic peroxide, 2,5-dimethyl-2,5-di(2-ethylhexanoylperoxy)hexane, 1-cyclohexyl-1-methylethylperoxy-2-ethyl hexanoate, t-hexylperoxy-2-ethyl hexanoate, t-butylperoxy-2-ethyl hexanoate, m-toluylbenzoyl peroxide, benzoyl peroxide, t-butylperoxy isobutylate, di-t-butylperoxy-2-methylcyclohexane, 1,1-bis (t-hexylperoxy)-3,5,5-trimethylcyclohexane, 1,1-bis (t-hexylperoxy)cyclohexane, 1,1-bis(t-butylperoxy)-3,5,5-trimethylcyclohexane, hydrogen peroxide and the like. Of these, hydrogen peroxide is preferred.

As examples of ionic polymerization initiators there may be mentioned water-soluble azobis compound initiators. Water-soluble azobis compound initiators are usually in the form of salts with counter ions for water solubility. Polymers obtained using such polymerization initiators have structures derived from the polymerization initiators at the polymerization initiation ends, and thus form salts in water and are ionic. However, even such types of polymers can be treated to convert their terminal ionic groups to non-ionic groups, for use as gas hydrate formation and dissociation-controlling agents according to the invention.

Also, while the use of a chain transfer agent is not essential in the polymerization, a chain transfer agent may also be used. However, as the structure derived from the chain transfer agent will also be introduced at the polymer end, a non-ionic species is preferred. Nevertheless, even polymers produced using ionic chain transfer agents can be later treated to convert their terminal ionic groups to non-ionic groups, for use as gas hydrate formation and dissociation-controlling agents according to the invention.

As examples of non-ionic chain transfer agents there may be mentioned alkylmercaptans such as n-butylmercaptan and n-octyl mercaptan, formaldehyde, acetaldehyde, propionaldehyde, n-butylaldehyde, isobutylaldehyde, diacetyl sulfide, ethylthioglycolate, 2-mercaptoethanol, 1,3-mercaptopropanol, 3-mercaptopropane-1,2-diol, 1,4-mercaptobutanol, thioglycerin, diethanol sulfide, thiodiglycol, ethylthioethanol, thiourea, allyl alcohol and the like. Preferred among these are alkylmercaptans, n-butylaldehyde, isobutylaldehyde, diacetyl sulfide, ethylthioglycolate, 2-mercaptoethanol, 1,3-mercaptopropanol and 3-mercaptopropane-1,2-diol. Among these preferred agents, hydroxyl group-containing mercaptans such as 2-mercaptoethanol, 1,3-mercaptopropanol and 3-mercaptopropane-1,2-diol are particularly preferred because the resulting polymers exhibit high gas hydrate formation and dissociation-controlling performance.

The following is surmised as the reason why polymers with non-ionic ends are preferred as gas hydrate formation and dissociation-controlling agents. Specifically, it is believed that, as the polymer ends do not bond with ionic compounds in water or do not very strongly attract water molecules, a suitable degree of interaction may be achieved between the gas and polymer in the water, thereby enhancing the gas hydrate formation and dissociation-controlling performance.

The reason for the high gas hydrate formation and dissociation-controlling performance of polymers obtained using hydroxyl group-containing mercaptans is thought to be that the hydroxyl groups at the polymerization initiation ends and/or polymerization termination ends of such polymers result in an even more suitable interaction between the gas or hydrates and the polymer.

The weight-average molecular weight of the polymer used for the invention is relatively low, in the range of 500-10,000. A smaller weight-average molecular weight results in greater mobility of the polymer molecules in water, thereby increasing the gas hydrate formation and dissociation-controlling performance, while a larger molecular weight increases the proportion of formation and dissociation control-exhibiting sites in the polymer.

While a larger weight-average molecular weight of the polymer will result in less of a non-ionic effect by the polymer ends, the effect is significant when the weight-average molecular weight of the polymer is 10,000 or below. For example, in the case of a polymer with a molecular weight of 10,000 or below obtained by homopolymerization of a monomer with a molecular weight of 100, the polymer will consist of no more than 100 monomers, such that the proportion of polymerization initiation ends will be 1% or greater and will have a major effect.

As examples of methods for obtaining polymers with weight-average molecular weights in the range of 500-10,000 there may be mentioned a method of using an excess of initiator, a method of using an excess of chain transfer agent, a method of using both an initiator and a chain transfer agent, a method of lowering the monomer concentration during polymerization, a method of carrying out the polymerization at high temperature, and a method of carrying out the polymerization at a temperature above the boiling point of the solvent, under pressurized conditions. Of these, the method of using an excess of initiator, the method of using an excess of chain transfer agent, and the method of using both an initiator and a chain transfer agent are preferred from the standpoint of equipment and cost.

A production method using hydrogen peroxide is especially preferred from the standpoint of equipment and cost, as well as the standpoint of achieving a polymer with high performance as a gas hydrate formation and dissociation-controlling agent. Hydrogen peroxide is thought to function as both a polymerization initiator and a chain transfer agent. In this case, hydroxyl groups derived from the hydrogen peroxide and solvent-derived end groups from chain transfer to the solvent are the main groups introduced at the polymer ends, to give a polymer with non-ionic ends.

As examples of methods of polymerization using hydrogen peroxide there may be mentioned a method of polymerizing an amphipathic monomer or an amphipathic monomer together with a hydrophilic monomer or hydrophobic monomer which is copolymerizable therewith, by adding them into the polymerization solvent with hydrogen peroxide. This method is preferred from the standpoint of obtaining low molecular weight polymers at high yields. The polymerization solvent used for this method is preferably an alcohol, more preferably a polyfunctional alcohol, and most preferably ethylene glycol.

In order to promote dissociation of the hydrogen peroxide, a dissociation promoter such as iron, copper, cobalt, manganese, a sulfite or an amine may be added. Of these, iron, copper, cobalt and manganese are preferred. It is not preferred to use a compound which produces ionic groups at the polymer ends by chain transfer or the like. However, even when a polymer with ionic groups at the polymer ends results, the terminal ionic groups can later be rendered non-ionic for use as a gas hydrate formation and dissociation-controlling agent according to the invention.

Although the reason that using hydrogen peroxide enhances the performance as a gas hydrate formation and dissociation-controlling agent is not fully understood, it is conjectured that the presence of hydroxyl groups at the ends is favorable for control of gas hydrate formation and dissociation.

The weight-average molecular weight of the polymer used for the invention may be determined by a publicly known method such as described, for example, in Mori et al., Anal. Chem., 55, 2414-2416(1983).

The gas hydrate formation and dissociation-controlling method of the invention comprises adding a gas hydrate formation and dissociation-controlling agent of the invention as described above, to a gas hydrate-forming system. Other formation and dissociation-controlling agents may also be added to the gas hydrate formation and dissociation-controlling agent. Examples of formation and dissociation-controlling agents which may be used therewith include hydrophilic polymers, ethylene glycol, triethylene glycol, methanol, ethanol, acetone and the like, but ethylene glycol and hydrophilic polymers are preferred. When another formation and dissociation-controlling agent is used, the proportion of the gas hydrate formation and dissociation-controlling agent of the invention, i.e. the amphipathic polymer having non-ionic ends, including the polymerization initiation and polymerization termination ends, and having a weight-average molecular weight in the range of 500-10,000, will usually be 1-80 wt %, preferably 20-60 wt % and most preferably 30-60 wt % in the formation and dissociation-controlling agent.

Here, a “gas hydrate-forming system” is a system in which a gas hydrate-forming substance is dissolved in an aqueous solvent as described, for example, on pages 1-9 of J. Long, A. Lederhos, A. Sum, R. Christiansen, E. D. Sloan; Prep. 73rd Ann. GPA Conv., 1994. In this type of system, the gas hydrate precipitates as crystals under specific pressure and temperature conditions.

As gas hydrate-forming substances there may be mentioned gases such as carbon dioxide, nitrogen, oxygen, hydrogen sulfide, argon, xenon, methane, ethane or propane, and liquids such as tetrahydrofuran.

As examples of gas hydrate-forming systems there may be mentioned a system wherein an aqueous phase with a gas such as ethane or propane dissolved in an aqueous solvent such as water or brine is suspended or dispersed in an oily phase such as liquefied gas or crude oil in a natural gas well or oil well, or a system wherein a gas phase such as natural gas is present in an aqueous phase.

There are no particular restrictions on the method of adding the gas hydrate formation and dissociation-controlling agent of the invention to a gas hydrate-forming system, but it is preferably added after dissolution in water and/or a water-miscible solvent. A water-miscible solvent is a solvent that mixes with water in any desired proportion, and examples thereof include methanol, ethanol, acetone and ethylene glycol.

The lower limit for the amount of addition of the gas hydrate formation and dissociation-controlling agent is preferably at least 0.01 part by weight and more preferably at least 1 part by weight with respect to 100 parts by weight of the free water in the gas hydrate-forming system. The upper limit is preferably no greater than 100 parts by weight and more preferably no greater than 50 parts by weight. A greater amount of the gas hydrate formation and dissociation controlling-agent improves the gas hydrate stabilizing effect, while a lesser amount lowers the viscosity of the system, thereby improving the fluidity.

When a gas hydrate formation and dissociation-controlling agent of the invention is used, various additives such as rust preventives, lubricants, dispersing agents, scaling inhibitors, corrosion inhibitors and the like may be used in combination therewith.

The present invention will now be explained in greater detail through examples and comparative examples, with the understanding that they are in no way limitative on the invention.

Polymer Molecular Weight Measuring Apparatus

The polymer molecular weight was measured with the following apparatus and measuring conditions.

Apparatus: 8010 System (RI detector) by Toso Corp.

Column: Shodex GPC KD-806M (8×300 mm) Ultrahydrogel 120 6 μ (8×300 mm)

Column temperature: 40° C. (thermostat)

Mobile phase: Dimethylformamide, 0.01 M lithium bromide

Flow rate: 0.8 ml/min

Standard polymer for molecular weight

calculation: Standard polyethylene glycol

Sample concentration: 0.1 wt % (DMF/LiBr solution)

Hydrate Formation/Dissociation-Controlling Agent Evaluating Apparatus

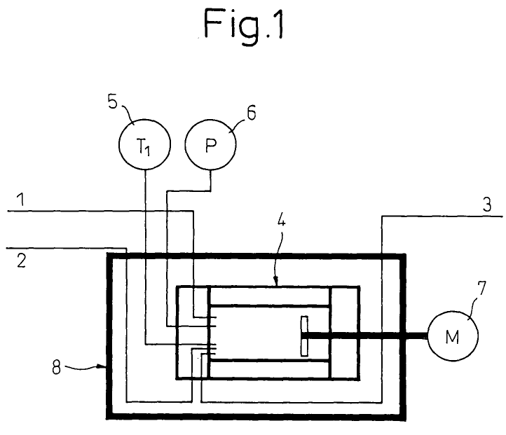

The gas hydrate formation temperature as the index of the gas hydrate formation-inhibiting performance of the gas hydrate formation and dissociation-controlling agent, and the gas hydrate dissociation completion temperature as the index of the gas hydrate stabilizing performance, were measured using the apparatus shown in FIG. 1.

In this apparatus, the high-pressure reaction cell 4 has an inner volume of 100 ml and a normal pressure-resistant design for up to 20 MPa. The cell is provided with a gas introduction line 1, a liquid introduction line 2, a purge line 3, an internal cell thermometer 5, an internal cell manometer 6 and a reaction cell stirrer 7. The entire cell was housed inside a thermostat 8 to allow adjustment of the internal cell temperature by the temperature of the thermostat 8. The high-pressure reaction cell 4 is provided with 3 cm-diameter observation ports (not shown) at three locations to allow the condition in the cell to be observed.

Formation-Inhibiting Performance Evaluation Method

The gas hydrate formation-inhibiting performance was evaluated in the following manner. Specifically, a 0.5 wt % aqueous solution of the gas hydrate formation and dissociation-controlling agent to be evaluated was introduced through the liquid introduction line 2 of the apparatus shown in FIG. 1, methane gas was introduced through the gas introduction line 1 to an internal cell pressure of 10 MPa, and the internal cell temperature was set to 20° C., a definite higher temperature than the formation equilibrium temperature of the methane hydrate at that pressure. The internal cell temperature was then slowly lowered at −4° C./hr while stirring the cell contents, and the state of methane hydrate formation in the cell at a given temperature was observed. The internal cell pressure was lowered by the methane hydrate formation, while the gas hydrate production slightly increased the internal cell temperature since it is an exothermic reaction. A lower internal cell temperature when the pressure begins to significantly fall, i.e. a lower methane hydrate formation temperature, was interpreted as greater gas hydrate formation-inhibiting performance.

Equilibrium Stabilization Performance Evaluation Method

The equilibrium stabilization performance was evaluated in the following manner. Specifically, after measuring the methane hydrate formation temperature in the performance evaluation described above, the thermostat temperature was lowered to 2° C. below the methane hydrate formation initiation temperature, and the gas was allowed to stand until the internal cell pressure and internal cell temperature became constant. When the internal cell temperature was then increased at 4° C./hr, the methane hydrate began to gradually dissociate inside the cell, finally separating completely into water and methane gas. A higher internal cell temperature, i.e. a higher methane hydrate dissociation completion temperature, was interpreted as greater gas hydrate equilibrium stabilization performance.

Kinetic Stabilization Performance Evaluation Method

The kinetic stabilization performance whereby the gas hydrate dissociation rate is kinetically reduced to delay gas hydrate dissociation was evaluated in the following manner. Specifically, after producing methane hydrate by the same procedure as for measurement of the methane hydrate formation temperature by the formation-inhibiting performance evaluation described above, the thermostat temperature was set to 2° C. and the gas was allowed to stand until the internal cell pressure and internal cell temperature became constant. Next, the methane gas in the cell was evacuated to an internal cell pressure of 2 MPa. The cell was sealed in this state, and the time until a constant internal cell pressure was reached was measured. A longer time (hereinafter referred to as “kinetic dissociation delay time”) was interpreted as greater kinetic stabilization performance for methane hydrate dissociation.

### EXAMPLE 1

After adding 120 g of 1,4-dioxane and 60 g of N-isopropylmethacrylamide (Mitsubishi Rayon) as an amphipathic monomer to a 300 ml separable flask equipped with a stirrer, condenser tube, nitrogen-introduction tube and thermocouple, and dissolving the monomer, nitrogen bubbling was performed for 30 minutes at a flow rate of 200 ml/min to remove the dissolved oxygen. The temperature in the flask was then raised to 80° C., after which there was added a solution of 3 g of 2,2′-azobisisobutyronitrile (V-60, Wako Pure Chemical Industries) as a polymerization initiator dissolved in 20 g of 1,4-dioxane, and polymerization was initiated. Polymerization was conducted while stirring under a nitrogen stream at a flow rate of 100 ml/min, and the reaction was continued for 6 hours at 80° C. This was allowed to cool, and 150 g of tetrahydrofuran was added to dilute the polymerization solution, which was then added dropwise to 3 L of n-hexane while stirring. After filtering off the obtained polymer, a vacuum drier was used at 60° C. for drying under reduced pressure overnight, to obtain 40 g of N-isopropylmethacrylamide polymer as a white powder. The weight-average molecular weight of the polymer was 4800 in terms of standard polyethylene glycol.

A gas hydrate formation and dissociation-controlling agent comprising the N-isopropylmethacrylamide polymer obtained in this manner was diluted with distilled water to a solid concentration of 0.5 wt % and, upon measuring the gas hydrate formation and dissociation-controlling performance, the gas hydrate formation temperature was 4° C., the gas hydrate dissociation completion temperature was 22° C., and the kinetic dissociation delay time was 530 minutes.

### EXAMPLES 2-5

Polymerization and gas hydrate formation and dissociation-controlling performance evaluations were conducted by the same procedure as in Example 1. The monomers, initiators, chain transfer agents, weight-average molecular weights, gas hydrate formation temperatures, gas hydrate dissociation completion temperatures and kinetic dissociation delay times are shown in Table 1.

TABLE 1

| | | | | | | Hydrate | |
|---|---|---|---|---|---|---|---|
| | | | | Weight- | Hydrate | dissociation | Kinetic |
| | Monomer type | | Chain | average | formation | completion | dissociation |
| | (Compositional) | | transfer | molecular | temperature | temperature | delay time |
| | ratio) | Initiator | agent | weight | (° C.) | (° C.) | (min) |
| Example | IPMA(100) | V-60 | — | 4,800 | 4.0 | 22.0 | 530 |
| 1 | | | | | | | |
| Example | IPMA(100) | V-59 | nBM | 2,400 | 4.0 | 23.0 | 540 |
| 2 | | | | | | | |
| Example | IPMA(100) | V-59 | MEt | 2,300 | 3.5 | 24.9 | 600 |
| 3 | | | | | | | |
| Example | DEAA(100) | V-60 | MEt | 4,000 | 4.0 | 20.0 | 500 |
| 4 | | | | | | | |
| Example | VCap(100) | V-60 | MEt | 2,800 | 5.0 | 18.0 | 420 |
| 5 | | | | | | | |

The compositional ratios are molar ratios.
Abbreviations:
IPMA: N-isopropylmethacrylamide
aDEAA: N,N-diethylacrylamide
VCap: N-vinylcaprolactam
V-60: 2,2′-azobisisobutyronitrile
V-59: 2,2′-azobis(2-methylbutyronitrile)
nBM: n-butylmercaptan
MEt: 2-mercaptoethanol

### EXAMPLE 6

After adding 250 g of ethylene glycol to a 1000 ml volatile substance-removable separable flask equipped with a stirrer, nitrogen-introduction tube and thermocouple, nitrogen bubbling was performed for 30 minutes at a flow rate of 200 ml/min, and the mixture was heated to 120° C. A mixture of 120 g of N-isopropylmethacrylamide (Mitsubishi Rayon) as an amphipathic monomer, 200 g of methanol and 108.2 g of 30 wt % hydrogen peroxide was added dropwise thereto over a period of 3 hours, for polymerization of the mixture. After completion of the dropwise addition, polymerization was continued for 1 hour at 120° C., to obtain 410 g of polymer solution. The polymerization was conducted while stirring under a nitrogen stream and removing the volatile substance composed mainly of methanol. This was allowed to cool, and 300 g of tetrahydrofuran was added to dilute the polymerization solution, which was then added dropwise to 6 L of n-hexane while stirring. After filtering off the obtained polymer, a vacuum drier was used at 60° C. for drying under reduced pressure overnight, to obtain 90 g of N-isopropylmethacrylamide polymer as a white powder.

As a result of measuring the molecular weight using a GPC with a dimethylformamide/lithium bromide solution as the mobile phase, the weight-average molecular weight of the polymer was found to be 700 in terms of standard polyethylene glycol.

The gas hydrate formation and dissociation-controlling performance of the polymer obtained in this manner was evaluated by the same procedure as in Example 1. The monomer, initiator, initiator amount, weight-average molecular weight, gas hydrate formation temperature, gas hydrate dissociation completion temperature and kinetic dissociation delay time are shown in Table 2.

### EXAMPLE 7

An N-isopropylmethacrylamide polymer was obtained by polymerization in the same manner as Example 6, except that the amount of hydrogen peroxide used was changed to 27.1 g. The gas hydrate formation and dissociation-controlling performance of the obtained polymer was evaluated by the same procedure as in Example 1. The monomer, initiator, initiator amount, weight-average molecular weight, gas hydrate formation temperature, gas hydrate dissociation completion temperature and kinetic dissociation delay time are shown in Table 2.

### EXAMPLE 8

An N-isopropylmethacrylamide polymer was obtained by polymerization in the same manner as Example 6, except that the dropwise addition and polymerization of the mixture of N-isopropylmethacrylamide, methanol and hydrogen peroxide for 3 hours was changed to 1 hour, and the continuation of polymerization for 1 hour after the dropwise addition was changed to 3 hours. The gas hydrate formation and dissociation-controlling performance of the obtained polymer was evaluated by the same procedure as in Example 1. The monomer, initiator, initiator amount, weight-average molecular weight, gas hydrate formation temperature, gas hydrate dissociation completion temperature and kinetic dissociation delay time are shown in Table 2.

### EXAMPLE 9

An N-isopropylmethacrylamide polymer was obtained by polymerization in the same manner as Example 6, except that FeSO₄.7H₂O was added to the ethylene glycol at 200 ppm in terms of Fe, the reaction temperature was 80° C., and an N-isopropylmethacrylamide powder and hydrogen peroxide were simultaneously added over a period of 3 hours, with no methanol. The gas hydrate formation and dissociation-controlling performance of the obtained polymer was evaluated by the same procedure as in Example 1. The monomer, initiator, initiator amount, dissociation promoter, weight-average molecular weight, gas hydrate formation temperature, gas hydrate dissociation completion temperature and kinetic dissociation delay time are shown in Table 2.

TABLE 2

| | | | | | | | Hydrate | |
|---|---|---|---|---|---|---|---|---|
| | Monomer | | Initiator | | Weight- | Hydrate | dissociation | Kinetic |
| | type | | amount | | average | formation | completion | dissociation |
| | (Compositional | | (initiator/ | Dissociation | molecular | temperature | temperature | delay time |
| | ratio) | Initiator | monomer) | promoter | weight | (° C.) | (° C.) | (min) |
| Example | IPMA(100) | H₂O₂ | 0.27 | — | 700 | 3.6 | 25.1 | 600 |
| 6 | | | | | | | | |
| Example | IPMA(100) | H₂O₂ | 0.068 | — | 1,500 | 3.7 | 25.5 | 620 |
| 7 | | | | | | | | |
| Example | IPMA(100) | H₂O₂ | 0.034 | — | 3,400 | 3.5 | 25.9 | 630 |
| 8 | | | | | | | | |
| Example | IPMA(100) | H₂O₂ | 0.10 | FeSO₄ | 2,200 | 3.6 | 25.8 | 600 |
| 9 | | | | | | | | |

The compositional ratios are molar ratios.
Abbreviation:
IPMA: N-isopropylmethacrylamide

### EXAMPLE 10

After adding 120 g of 1,4-dioxane, 57 g of N-isopropylmethacrylamide (Mitsubishi Rayon) as an amphipathic monomer and 3 g of acrylamide to a 300 ml separable flask equipped with a stirrer, condenser tube, nitrogen-introduction tube and thermocouple, and dissolving the monomer, nitrogen bubbling was performed for 30 minutes at a flow rate of 200 ml/min to remove the dissolved oxygen. The temperature in the flask was then raised to 80° C., after which there was added a solution of 3 g of 2,2′-azobisisobutyronitrile (v-60, Wako Pure Chemical Industries) as a polymerization initiator dissolved in 20 g of 1,4-dioxane, and polymerization was initiated. Polymerization was conducted while stirring under a nitrogen stream at a flow rate of 100 ml/min, and the reaction was continued for 5 hours at 80° C. This was allowed to cool, and 150 g of tetrahydrofuran was added to dilute the polymerization solution, which was then added dropwise to 3 L of n-hexane while stirring. After filtering off the obtained polymer, a vacuum drier was used at 60° C. for drying under reduced pressure overnight, to obtain 28 g of a white powder.

As a result of measuring the molecular weight using a GPC with a dimethylformamide/lithium bromide solution as the mobile phase, the weight-average molecular weight of the polymer was found to be 3100 in terms of standard polyethylene glycol.

A gas hydrate formation and dissociation-controlling agent comprising the N-isopropylmethacrylamide/acrylamide copolymer obtained in this manner was diluted with distilled water to a solid concentration of 0.5 wt %, and upon measuring the gas hydrate formation and dissociation-controlling performance, the gas hydrate formation temperature was 5° C., the gas hydrate dissociation completion temperature was 17.9° C., and the kinetic dissociation delay time was 490 minutes.

### EXAMPLES 11-13

Polymerization and gas hydrate formation and dissociation-controlling performance evaluation were conducted by the same procedure as in Example 10. The monomers, initiators, chain transfer agents, weight-average molecular weights, gas hydrate formation temperatures, gas hydrate dissociation completion temperatures and kinetic dissociation delay times are shown in Table 3.

TABLE 3

| | | | | | | Hydrate | |
|---|---|---|---|---|---|---|---|
| | | | | Weight- | Hydrate | dissociation | Kinetic |
| | Monomer type | | Chain | average | formation | completion | dissociation |
| | (Compositional | | transfer | molecular | temperature | temperature | delay time |
| | ratio) | Initiator | agent | weight | (° C.) | (° C.) | (min) |
| Example | IPMA/AAm(90/10) | V-60 | — | 3,100 | 5.0 | 17.9 | 490 |
| 10 | | | | | | | |
| Example | IPMA/THFMA(90/10) | V-59 | nOM | 7,800 | 5.0 | 18.5 | 405 |
| 11 | | | | | | | |
| Example | DEAA/AAm(70/30) | V-59 | — | 1,800 | 5.5 | 19.0 | 420 |
| 12 | | | | | | | |
| Example | VCap/HEMA(80/20) | V-60 | nOM | 5,600 | 5.1 | 17.5 | 400 |
| 13 | | | | | | | |

The compositional ratios are molar ratios.
Abbreviations:
IPMA: N-isopropylmethacrylamide
AAm: acrylamide
THFMA: tetrahydrofurfuryl methacrylate
DEAA: N,N-diethylacrylamide
VCap: N-vinylcaprolactam
HEMA: hydroxyethyl methacrylate
V-60: 2,2′-azobisisobutyronitrile
V-59: 2,2′-azobis(2-methylbutyronitrile)
nOM: n-octylmercaptan

### EXAMPLE 14

Polymerization and gas hydrate formation and dissociation-controlling performance evaluation were conducted by the same procedure as in Example 8, except that the amphipathic monomers were changed to 114 g of N-isopropylmethacrylamide (Mitsubishi Rayon) and 6 g of acrylamide. The monomer, initiator, initiator amount, weight-average molecular weight, gas hydrate formation temperature, gas hydrate dissociation completion temperature and kinetic dissociation delay time are shown in Table 4.

TABLE 4

| | | | | | | Hydrate | |
|---|---|---|---|---|---|---|---|
| | Monomer | | Initiator | Weight- | Hydrate | dissociation | Kinetic |
| | type | | amount | average | formation | completion | dissociation |
| | (Compositional | | (initiator/ | molecular | temperature | temperature | delay time |
| | ratio) | Initiator | monomer) | weight | (° C.) | (° C.) | (min) |
| Example | IPMA/AAm(90/10) | H₂O₂ | 0.034 | 3,800 | 4.5 | 18.6 | 520 |
| 14 | | | | | | | |

The compositional ratio is a molar ratio.
Abbreviations:
IPMA: N-isopropylmethacrylamide
AAm: acrylamide

### EXAMPLE 15

After adding 80 g of N-isopropylmethacrylamide (Mitsubishi Rayon), as an amphipathic monomer, to a 1000 ml separable flask equipped with a stirrer, condenser, nitrogen-introduction tube and thermocouple, and heating to 90° C., there were added 0.24 g of 2,2′-azobis (2-methylbutyronitrile) (V-59, product of Wako Pure Chemical Industries), 0.12 g of 2,2′-azobis(cyclohexane-1-carbonitrile (V-40, product of Wako Pure Chemical Industries) and 6 g of 2-mercaptoethanol while stirring, and then polymerization was conducted for 4 hours while stirring at 90-100° C. The product was allowed to cool, and 200 g of tetrahydrofuran was added to dilute the polymerization solution, which was then added dropwise to 6 L of n-hexane while stirring. After filtering off the obtained polymer, a vacuum drier was used at 60° C. for drying under reduced pressure overnight, to obtain 60 g of N-isopropylmethacrylamide polymer as a white powder.

As a result of measuring the molecular weight using a GPC with a dimethylformamide/lithium bromide solution as the mobile phase, the weight-average molecular weight of the polymer was found to be 2300 in terms of standard polyethylene glycol.

The gas hydrate formation and dissociation-controlling performance of the polymer obtained in this manner was evaluated by the same procedure as in Example 1. The monomer, initiator, chain transfer agent, weight-average molecular weight, gas hydrate formation temperature, gas hydrate dissociation completion temperature and kinetic dissociation delay time are shown in Table 5.

TABLE 5

| | | | | | | Hydrate | |
|---|---|---|---|---|---|---|---|
| | | | | Weight- | Hydrate | dissociation | Kinetic |
| | Monomer type | | Chain | average | formation | completion | dissociation |
| | (Compositional | | transfer | molecular | temperature | temperature | delay time |
| | ratio) | Initiator | agent | weight | (° C.) | (° C.) | (min) |
| Example | IPMA(100) | V-59/V-40 | MEt | 2,500 | 3.8 | 25.0 | 610 |
| 15 | | | | | | | |

The compositional ratio is a molar ratio.
Abbreviations:
IPMA: N-isopropylmethacrylamide
V-59: 2,2′-azobis(2-methylbutyronitrile)
V-40: 2,2′-azobis(cyclohexane-1-carbonitrile)
MEt: 2-mercaptoethanol

### COMPARATIVE EXAMPLE 1

After adding 120 g of distilled water and 60 g of N-isopropylmethacrylamide (Mitsubishi Rayon), as an amphipathic monomer, to a 300 ml separable flask equipped with a stirrer, condenser tube, nitrogen-introduction tube and thermocouple, nitrogen bubbling was performed for 30 minutes at a flow rate of 200 ml/min to remove the dissolved oxygen. The temperature in the flask was then raised to 80° C., after which there was added a solution of 5 g of 2,2′-azobis(2-methylpropionamide) dihydrochloride (V-50, Wako Pure Chemical Industries) as a polymerization initiator dissolved in 20 g of distilled water, and polymerization was initiated. N-isopropylmethacrylamide only dissolves in water to approximately 10% at 80° C. but, as the polymer becomes more water-soluble as polymerization proceeds, the amount of undissolved monomer tends to decrease. On the other hand, poly (N-isopropylmethacrylamide) has a lower critical solution temperature of approximately 42° C., and it is insoluble in water at 80° C. The solution therefore becomes cloudy during polymerization. Polymerization was conducted while stirring under a nitrogen stream at a flow rate of 100 ml/min, and the reaction was continued for 5 hours at 80° C. This was allowed to cool, and 150 g of acetone was added to dilute the polymerization solution, which was then concentrated to dryness with a rotary evaporator. The obtained crude polymer was redissolved in 300 ml of acetone, and the solution was added dropwise to 3 L of n-hexane while stirring. After filtering off the obtained polymer, a vacuum drier was used at 60° C. for drying under reduced pressure overnight, to obtain 32 g of N-isopropylmethacrylamide/ acrylamide copolymer as a white powder. The weight-average molecular weight of the copolymer was 4000 in terms of standard polyethylene glycol.

A gas hydrate formation and dissociation-controlling agent comprising the N-isopropylmethacrylamide polymer obtained in this manner was diluted with distilled water to a solid concentration of 0.5 wt %, and upon measuring the gas hydrate formation and dissociation-controlling performance, the gas hydrate formation temperature was 6° C., the gas hydrate dissociation completion temperature was 16.5° C., and the kinetic dissociation delay time was 220 minutes.

### COMPARATIVE EXAMPLES 2-4

Polymerization and gas hydrate formation and dissociation-controlling performance evaluation were conducted by the same procedure as in Example 1 for Comparative Example 2 and by the same procedure as in Comparative Example 1 for Comparative Examples 3 and 4. The monomers, initiators, chain transfer agents, weight-average molecular weights, gas hydrate formation temperatures, gas hydrate dissociation completion temperatures and kinetic dissociation delay times are shown in Table 6.

TABLE 6

| | | | | | | Hydrate | |
|---|---|---|---|---|---|---|---|
| | | | | Weight- | Hydrate | dissociation | Kinetic |
| | Monomer type | | Chain | average | formation | completion | dissociation |
| | (Compositional | | transfer | molecular | temperature | temperature | delay time |
| | ratio) | Initiator | agent | weight | (° C.) | (° C.) | (min) |
| Comp. Ex. 1 | IPMA(100) | V-50 | — | 4,000 | 6.5 | 15.5 | 220 |
| Comp. Ex. 2 | IPMA(100) | V-60 | — | 38,000 | 5.5 | 17.5 | 350 |
| Comp. Ex. 3 | DEAA/AAm(70/30) | VA-044 | Met | 5,800 | 5.5 | 17.0 | 300 |
| Comp. Ex. 4 | Vcap/HEMA(80/20) | VA-044 | — | 76,000 | 6.1 | 17.2 | 330 |

The compositional ratios are molar ratios.
Abbreviations:
IPMA: N-isopropylmethacrylamide
IPAA: N-isopropylacrylamide
DEAA: N,N-diethylacrylamide
AAm: acrylamide
VCap: N-vinylcaprolactam
HEMA: hydroxyethyl methacrylate
V-50: 2,2′-azobis(2-methylpropionamide) dihydrochloride
V-60: 2,2′-azobisisobutyronitrile
VA-044: 2,2′-azobis[2-(2-imidazolin-2-yl)propane] dihydrochloride
MEt: 2-mercaptoethanol

Industrial Applicability

The gas hydrate formation and dissociation-controlling agents of the invention have an inhibiting effect to control formation of gas hydrates under conditions in which gas hydrates form and an effect of equilibrium and kinetic stabilization of gas hydrates under conditions in which gas hydrates undergo gradual dissociation. By using gas hydrate formation and dissociation-controlling agents of the invention having both of these effects, it is possible to achieve effective control over gas hydrate formation and dissociation.

1. A gas hydrate formation and dissociation-controlling agent which is an amphipathic polymer having non-ionic polymerization initiation and polymerization termination ends of the polymer, and having a weight-average molecular weight in the range of 500-10,000.

2. A controlling agent according to claim 1, wherein the amphipathic polymer is obtained by (co) polymerization of an amphipathic monomer.

3. A controlling agent according to claim 1 or 2, wherein either or both the polymerization initiation and polymerization termination ends of said polymer are hydroxyl groups.

4. A controlling agent according to claim 3, wherein said polymer is polymerized or copolymerized using hydrogen peroxide as the polymerization initiator.

5. A controlling agent according to any one of claims 1 to 4, wherein said polymer is polymerized or copolymerized in the presence of a hydroxyl group-containing mercaptan.

6. A controlling agent according to any one of claims 2 to 5, wherein said polymer is obtained by (co)polymerization of N-isopropylmethacrylamide.

7. A gas hydrate formation and dissociation-controlling method which comprises adding a gas hydrate formation and dissociation-controlling agent according to any one of claims 1 to 6 to a gas hydrate-forming system.

8. A method according to claim 7, wherein the gas hydrate formation and dissociation-controlling agent is added to the gas hydrate-forming system as a solution dissolved in water and/or a water-miscible solvent.

9. A method according to claim 7 or 8, wherein the amount of the gas hydrate formation and dissociation-controlling agent added is 0.01 to 100 parts by weight with respect to 100 parts by weight of free water in the gas hydrate-forming system.
